(19) United States
(12) Patent Application Publication
(10) Pub. No.: US 2006/0083664 A1
(43) Pub. Date: Apr. 20, 2006

(54) Multi-well plates

(75) Inventor: James Allen Bahr, West Fargo, ND (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: North Dakota State University, Fargo, ND (US)

(21) Appl. No.: 11/155,294

(22) Filed: Jun. 17, 2005

Related U.S. Application Data
(60) Provisional application No. 60/581,224, filed on Jun. 18, 2004.

(51) Int. Cl. B01L 3/00

(52) U.S. Cl. 422/102; 422/56

(57) ABSTRACT

A test panel for use in preparing a coating array, includes a plate having a non-corrosive surface and a plurality of raised edges integrally formed as part of the non-corrosive surface. The raised edges define a plurality of wells. Also disclosed is a method of testing coatings placed on a panel.

### CROSS-REFERENCE TO RELATED APPLICATION(S)

The present application claims priority to U.S. Provisional Patent App. No. 60/581,224, entitled “Multi-Well Plates” by James Allen Bahr, filed Jun. 18, 2004, which is hereby incorporated by reference in its entirety.

### STATEMENT OF GOVERNMENT INTEREST

The present invention was made, in part, with government finding under the Office of Naval Research (ONR), Grant Nos. N00014-03-1-0702 and N00014-04-1-0597. The U.S. Government has certain rights in this invention.

### BACKGROUND OF THE INVENTION

Traditional coating test panels are flat and are formed of a material such as aluminum. Spray orblading techniques are used to deposit a coating sample onto a test panel. Each test panel, containing one type of coating, is then tested, such as by subjecting the panel to weathering, corrosion or various coating property determination testing.

In many laboratories, it is desired to develop coatings using a high throughput workflow. In such instances, it is desired to apply multiple coatings to one test panel in the form of an array so that several varieties of coatings can be tested at once. However, there are many challenges to applying an array of coatings to standard test panels.

Standard test panels are about four inches by about 8 inches. To allow for a coating array, about twelve coatings may be applied to the test panel. When applying the coatings to the panel, a small amount of coating is deposited on the panel in the desired location. To allow for application of multiple coatings, each coating in the array must be applied to a location on the test panel that keeps the coating separate from an adjacent coating. In doing so, it is difficult to ensure the same amount of coating is applied to form each area of the coating array.

Further, it is difficult to ensure each coating in the test array is applied at a uniform thickness. The coatings may bleed into adjacent coatings on the array, while other coatings may be deposited so that the coating is thicker. Further, it is difficult to ensure each sample has the same thickness at all areas of the coating sample. For instance, the coating sample may be thinner at the edges of the sample. Such deviations can have an effect on the reliability of the tests performed on the test panel.

In an attempt to obtain a uniform thickness of all the coatings being tested, the sample may be bladed, such as by using a doctor blade. To obtain uniform coating samples on the array, it is possible to attempt to control the blading operation based on the volume of each coating applied, the desired thickness of each sample, or even the speed at which the blade is moved across each sample. Still, given the diverse array of coatings, some may blade nicely, while others may not blade at all.

Furthermore, when developing new coatings, there are many unknowns. For instance, it is not always possible to predict how easily or evenly the coating can be bladed to achieve the desired uniform surface. Some coatings may shrink or ball, while others may set very quickly, making it hard to blade them as desired. Still others may be extremely viscous, or spread out quickly on the test panel before they can be bladed. In such instances, some areas of the coating will be thicker than others.

Other test coating application problems can be stated as follows: (1) coating patch maximum dry film thickness achieved is about 50 microns, and subsequent adhesion and immersion testing require 200-500 micron film thicknesses to be valid; (2) bladed patches exhibit thinning from top to bottom as much as 100%; (3) only one set of blading parameters can be set for the entire array, and most arrays will contain 12-24 different formulations, therefore, not all elements will be coated properly and these parameters need to be optimized for each individual array before the run; and (4) a 24 element application takes 45 minutes, but it is difficult to maintain constant viscosity across the entire array, therefore, initial patches look good while later patches may start to gel making it impossible to blade out.

Thus, there is a need in the art for a test panel that allows for high throughput workflow, and which ensures an even application of multiple test coatings in the array.

### BRIEF SUMMARY OF THE INVENTION

The present invention comprises a test panel formed having multiple test wells. The test wells allow coatings to be deposited individually into the wells and cast in place. Thicker, smoother coating samples can be generated over a wider range of viscosities. Also disclosed is a method of testing coatings placed on a panel.

### BRIEF DESCRIPTION OF THE DRAWINGS

FIG. 1 is a top plan view of a test panel of the present invention showing the multiple wells and coatings applied therein.

FIG. 2 is a perspective view of a test panel of the present invention containing coatings in the wells.

FIG. 3 is a top view of the test panel of the present invention.

FIGS. 4A and 4B are sectional views of the test panel of the present invention.

FIG. 5 is a top view of another embodiment of a test panel of the present invention.

### DETAILED DESCRIPTION

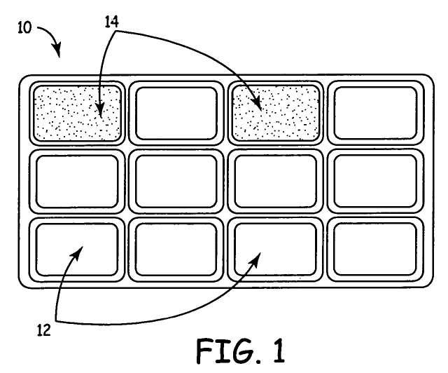

FIG. 1 is a top view of a test panel 10 for high throughput testing of various materials, such as coatings. The test panel 10 comprises multiple wells 12 arranged on the test panel 10. Some of the top row of the wells 12 contain a variety of coatings 14.

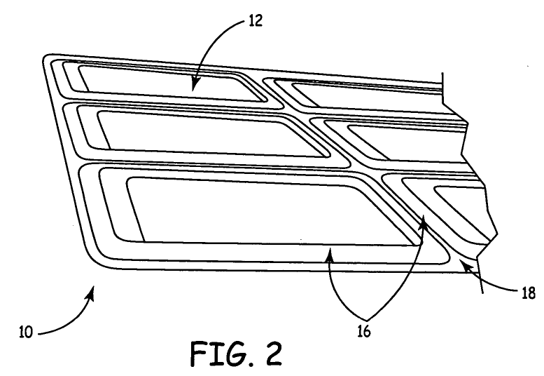

FIG. 2 is a side perspective view of the test panel 10 more clearly illustrating the wells 12. Each well 12 is defined by a raised edge 16 formed in a rectangle. Between each raised edge 16 are flat areas 18, which separate each well 12 from the adjacent well 12.

The test panel 10 may be formed of any suitable material. Preferably, the test panel is formed of a material that is non-corrosive and non-reactive to allow the test panel to be used in a variety of coating and testing operations. One suitable material is aluminum. Another suitable material is an alloy with a relatively low melting temperature, such as an alloy of bismuth, lead, tin, cadmium and indium that is commercially available as “Cerrolow 117” from McMaster Carr, Chicago, Ill.

The test panel 10 can be formed using any suitable method. For example, it is possible to form the test panel 10 by simply stamping commercially available test panels to form the wells 12. To do so, the test panels 12 are simply fed into a press configured to form the raised edges 16 of each well 12.

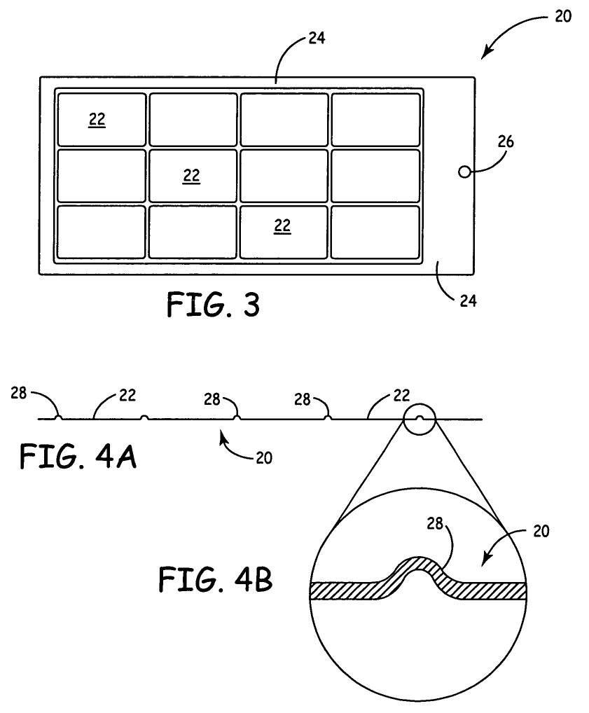

FIG. 3 is a top plan view of one embodiment of a test panel 20 according to the present invention. The test panel 20 is approximately eight inches by four inches and comprises twelve wells 22. Each well 22 is about 1.606 inches by about 1.069 inches and has a substantially flat bottom surface. The test panel 20 further comprises a flat edge 24 which surrounds the wells. One end of the flat edge 24 contains a hole 26. Both the flat edge 24 and the hole 26 serve to facilitate handling of the panel 20.

FIGS. 4A and 4B are sectional views of the panel 20 taken along line A-A in FIG. 3. Each well 22 is bounded by a raised edge 28. FIG. 4 further comprises an enlarged cross-sectional view of one of the raised edges 28.

In one embodiment, the raised edge 28 can have a width of about 0.125 inches. The height of the raised edge 28 can be about 0.060 inches, while the thickness of the panel 20 can be about 0.040 inches.

The preferred depths of the test wells can vary based on the type of testing performed and the type of coating being tested. When testing certain types of coatings, the desired depth of each well 22 can range from a depth that allows for achieving a coating sample that is about 300 microns thick to about 1500 microns thick.

The test panel 20 has many advantages over previous panels used in test coating applications. For instance, the test panel allows for multiple coatings to be applied to one panel. Because the coatings are applied to the wells 22, it is easier to apply each coating at a uniform thickness across the entire sample of the coating. Further, there is no risk that one coating will bleed into an adjacent coating. Previously, not all types of coatings could be tested using a flat test panel. With the test panel having the defined test wells, a wider variety of coatings can be tested using the test panel. If the coating can be poured into the well, a film can be cast for testing.

The coatings can be applied to the test panel simply by dispensing the desired volume into each well. Rather than applying a single coating to one panel, several coatings can be applied to a single panel. Less coating material is required for each test, while the number of coatings that can be tested at one time is increased. The test panel can also be used in highly automated applications, with each coating simply being poured or applied to each test well. No blading step is needed. In this way, the test panel makes it more convenient for obtaining multiple arrays of coatings for testing.

Further, no special machines are needed for dispensing the coatings onto the test panels, and no special machines are needed to blade each sample in an attempt to obtain a uniform thickness. As such, coatings can be applied to the test panels at any convenient location, such as the laboratories where the coatings are being developed, rather than having to apply the coatings to the test panels at the location where the testing is to be performed. The test panels reduce the number of steps and time involved in creating the test panel array, which greatly increases productivity.

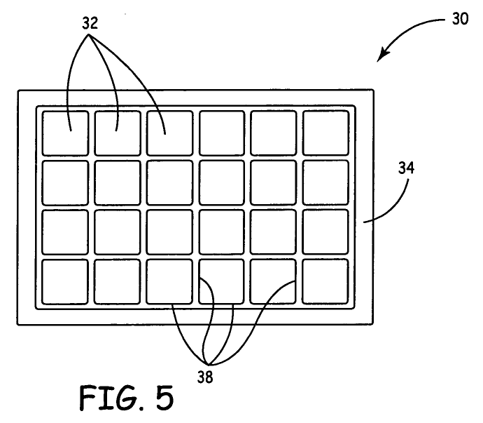

FIG. 5 is a top view of another embodiment of a test panel 30. Panel 30 is generally similar to panel 20, and includes wells 32, flat edge 34, and raised edge 38. Plate 30 comprises twenty-four wells 32. The test panel 30 is approximately five inches by 3.375 inches. Each well 32 is about 0.739 inches by about 0.703 inches. In one embodiment, the raised edge 38 has a width of about 0.0625 inches. The height of the raised edge 38 can be about 0.060 inches, while the thickness of the panel 30 is 0.040 inches.

Test panels according to the present invention that are formed of an alloy with a low melting temperature provide an additional benefit. Such test panels can be heated so that the test panel material separates from one or more coating samples in the wells of the test panel, leaving free-standing coating samples. In this way the test panel material “melts away” from the coating samples. For example, where test panels are formed of the “Cerrolow 117” alloy described above, the test panel material melts at about 117° F. Samples can thus be removed from the test panel by heating the test panel to 117° F. or greater. Other alloys can be used that have different melting points. Particular alloys used can be selected based upon factors such as cost, malleability, and the ability to melt the alloy at a low enough temperature such that heating the test panel does not adversely affect the coating samples.

Though embodiments have been described for test panels having particular dimensions, the invention is not so limited. Rather, the test panels can be of any suitable size which accommodates not only the test equipment, but also results in test wells having the desired size to allow for the desired testing to be performed on each coating sample. For instance, when testing some forms of coatings, it is necessary to perform three tests on each test well in an effort to achieve statistically sound test results. In such instances, each test well must have the required surface area and size to allow for three tests to be performed on each coating in the test well.

An eight inch by four inch test panel is preferred for coatings applications because such panels fit standardized laboratory equipment. Test panels of this size and having twelve wells are preferable, because such test panels can be used with existing laboratory equipment that allows for application of multiple coatings using robots and other forms of automation. Similarly, panels having twelve wells can be used in 24 element libraries (i.e., with two discrete panels). However, the invention is not so limited, and any number of wells can be formed on the test panel. For instance, five inch by 3.375 inch panels with twenty-four wells are preferred for biotech applications.

The size of the wells on each test panel is also not limited to that described with reference to embodiments shown in FIGS. 4-5. Rather the test panels can be formed to have test wells of any desired size. Further, the test wells can have any depth necessary for use in the desired tests.

Benefits of the test panels according to the present invention can be described as follows: (a) uniform thicknesses up to 1000 microns obtainable; (b) a 24 element array can be deposited in less than 5 minutes; (c) tolerates diverse coating array formulations; (d) no solvent/elastomer incompatibilities as seen with earlier casting templates; and (e) multi-well plates can be sent out, in kit form, for offsite coating deposition, and then returned to the original lab for analysis. Existing technologies do not allow these features and benefits.

Although the present invention has been described with reference to preferred embodiments, workers skilled in the art will recognize that changes may be made in form and detail without departing from the spirit and scope of the invention.

1. A test panel for use in preparing a coating array, the test panel comprising:
a plate having a non-corrosive surface; and
a plurality of raised edges integrally formed as part of the non-corrosive surface, the raised edges defining a plurality of wells.

2. The test panel of claim 2 wherein the test panel is formed of aluminum.

3. The test panel of claim 1 wherein the raised edges define a plurality of generally rectangular wells.

4. The test panel of claim 1 wherein test panel is approximately eight inches by approximately four inches.

5. The test panel of claim 1 wherein the test panel comprises at least twelve generally rectangular wells.

6. The test panel of claim 1 wherein each well is about 1.6 inches by about 1.1 inches.

7. The test panel of claim 1 wherein the raised edges are about 0.06 inches high.

8. The test panel of claim 1 wherein at least one of the plurality of wells having a substantially flat bottom surface.

9. The test panel of claim 1 wherein the test panel is formed of an alloy of bismuth, lead, tin, cadmium and indium.

10. A test panel for use in preparing and testing a coating array, the test panel comprising:
a plurality of wells, each well formed by a base surrounded by a plurality of raised edges; and
a flat region at a perimeter of the test panel and generally coplanar with the bases of the wells.

11. The test panel of claim 10 wherein the plurality of raised edges forms a plurality of generally rectangular wells on the test panel.

12. The test panel of claim 10 wherein the test panel is formed of a non-corrosive material.

13. The test panel of claim 10 wherein the test panel comprises twenty-four wells.

14. The test panel of claim 10 wherein the test panel comprises twelve wells.

15. The test panel of claim 10 wherein the test panel is formed of an alloy of bismuth, lead, tin, cadmium and indium.

16. The test panel of claim 10 wherein the test panel is formed of aluminum.

17. A method of testing an array of coatings, the method comprising:
providing a metallic test panel comprising a plurality of wells defined by a plurality of raised edges;
dispensing an amount of coating into at least one well; and
testing the coatings.

18. The method of claim 17 and further comprising causing the coatings to dry prior to testing.

19. The method of claim 18 and further comprising heating the test panel.

20. The method of claim 19 and further comprising separating at least one of the coatings from the test panel.
